(19) United States
(12) Patent Application Publication
(10) Pub. No.: US 2014/0072934 A1
(43) Pub. Date: Mar. 13, 2014

(54) PERIODONTAL DISEASE DEVICES AND METHODS

(71) Applicant: William F. McKay, Memphis, TN (US)

(72) Inventor: William F. McKay, Memphis, TN (US)

(73) Assignee: Warsaw Orthopedic, Inc., Warsaw, IN (US)

(21) Appl. No.: 13/608,704

(22) Filed: Sep. 10, 2012

(51) Int. Cl. A61C 19/06

(52) U.S. Cl. 433/215

(57) ABSTRACT

Devices and methods are provided for treating a periodontal defect adjacent to a tooth, the devices and methods use a barrier configured to reduce an amount of material from entering into the periodontal defect, the barrier having a first region configured to retain a portion of the barrier against at least a portion of the tooth and a second region configured to extend over at least a portion of the periodontal defect adjacent to the tooth so as to reduce the amount of material from entering into the periodontal defect. In some embodiments, the devices and methods provided can be removed from the healed periodontal defect without the need to cut into healed soft tissue.

### BACKGROUND

During the early stages of periodontal disease, known commonly as gingivitis, bacteria on the teeth and near the gingiva infect and irritate the sulcus where the gingiva approximates the tooth. The presence of bacteria can lead to destruction of the gingival epithelium, which connects the gingiva to the tooth and can force the epithelium to separate from the root of the tooth. Also, as a result of bacterial presence, inflammatory cells increasingly populate the gingival tissues. Thus, the tissue is weaker due to the disease, and attachment is lessened. Of course, further infection moves the tissue attachment further toward the apex of the tooth, creating a pathological pocket much deeper than the normal sulcus.

Naturally, this pocket is difficult to clean or floss because the routine cleaning instruments of normal home care cannot reach the bacteria or plaque, which accumulate within the pocket. As disease extends the pocket, the periodontal ligament which attaches the tooth to the supporting bone, and the supporting alveolar bone itself, are destroyed. This disease leaves a periodontal defect, filled with plaque, food, and bacteria. Ultimately, the tooth could be surrounded by loose, diseased, and detached gingiva. Eventually such deterioration can result in the loss of the tooth.

One conventional treatment of periodontal defects involves surgically gaining access to the tooth root surface in an effort to remove bacteria and possible infected soft tissue and to alter the periodontal pocket or obtain reattachment of the connective tissue toward the crown of the tooth. Some of the former methods accomplish this attachment by cutting away gingival tissue near the crown of the tooth and, if necessary, shaping underlying bone to create a sulcus similar in depth to a normal sulcus so that regular oral hygiene may be used to maintain attachment of the gingiva to the tooth. Of course, such treatment does not recreate the attachment of the gingiva near the crown like that which existed before any diseased condition. Such treatment also does not replace any periodontium lost to disease.

Another conventional treatment for periodontal disease involves gingival flap surgical procedures, where one or more flaps of gingival tissue are retracted from the tooth. After the tooth root is thoroughly cleaned, and diseased soft tissue is removed, these flaps are reopposed to the tooth. In some instances bone replacement material (e.g., bone grafts, alveolar bone cells, and/or periodontal ligament tissue, etc.) from other portions of the mouth are incorporated into the periodontal defect. Typically, after periodontal surgery, a race begins among the cells from the four types of periodontal tissues, gingival epithelium, gingival connective tissue, alveolar bone and periodontal ligament, to repopulate the previously diseased root surface.

Gingival epithelium and gingival connective tissue cells migrate rapidly along the tooth root toward the apex of the tooth, while alveolar bone cells, bone cementum cells, and periodontal ligament cells migrate much more slowly. If the gingival tissue is allowed to migrate in an uncontrolled way toward the base of the periodontal defect, the gingival tissue will compress the bone replacement material and it will not retain its shape. Further, downgrowth of gingival epithelium and gingival connective tissue cells into the periodontal defect will reduce migration of alveolar bone cells, bone cementum cells, and periodontal ligament cells and inhibit proper healing of the defect. Therefore, gingival flap surgical procedures tend to be unpredictable.

In some surgical procedures, the periodontal defect is exposed to saliva, other liquids, food and bacteria, which can interfere with the natural repair process by washing away biological growth factors that facilitate repair of the defect.

Therefore, there is a need for devices and methods that protect the periodontal defect from exposure to saliva, other liquids, food, bacteria that can slow healing of the defect. Further there is a need for devices and methods that reduce the number of surgical procedures required to cut into gingival tissue that has already healed.

### SUMMARY

Devices and methods are provided that protect the periodontal defect from saliva, other liquids, food, bacteria and/or other material that slows healing of the periodontal defect.

In some embodiments, the devices and methods provided reduce the number of surgical procedures required to cut into gingival tissue that has healed from prior surgeries.

In some embodiments, the devices and methods allow guided tissue regeneration where the cementum, alveolar bone and periodontal ligament producing cells have the ability to become established on the tooth root surface by isolating the periodontal defect from unwanted saliva, other liquids, food, bacteria and/or other material that slows healing of the periodontal defect. The devices and methods provided allow proper healing of the periodontal defect and, in some embodiments, gingival tissue can be attached to it.

In some embodiments, there is a device for treating a periodontal defect adjacent to a tooth, the device comprising a barrier configured to reduce an amount of material from entering into the periodontal defect, the barrier having a first region configured to retain a portion of the barrier against at least a portion of the tooth and a second region configured to extend over at least a portion of the periodontal defect adjacent to the tooth so as to reduce the amount of material from entering into the periodontal defect.

In some embodiments, there is a device for treating a periodontal defect adjacent to a tooth, the device comprising a barrier configured to reduce an amount of material from entering into the periodontal defect, the barrier having a first region comprising (i) a hole configured to receive and slide over at least a portion of one or more teeth to retain at least the first region of the barrier against the portion of the one or more teeth; or (ii) an interior surface having an adhesive disposed on a portion of the interior surface to retain a portion of the first region against a surface of the tooth; and a second region configured to extend over at least a portion of the periodontal defect adjacent to the tooth so as to reduce the amount of material from entering into the periodontal defect.

In some embodiments, there is a method for treating a periodontal defect adjacent to a tooth, the method comprising providing a barrier configured to reduce an amount of material from entering into the periodontal defect, the barrier having a first region configured to retain a portion of the barrier against at least a portion of the tooth and a second region configured to extend over at least a portion of the periodontal defect adjacent to the tooth so as to reduce the amount of material from entering into the periodontal defect; placing the first region of the barrier against the portion of the tooth so as to retain it against the portion of the tooth; and extending the second region of the barrier over at least a portion of the periodontal defect; and attaching the second region of the barrier to gingival tissue adjacent to the periodontal defect so as to reduce the amount of material from entering into the periodontal defect.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

In part, other aspects, features, benefits and advantages of the embodiments will be apparent with regard to the following description, appended claims and accompanying drawings where:

FIG. 1 is a schematic front view of an embodiment of the device that shields all or a portion of the periodontal defect from material that slows healing of the periodontal defect. The device comprises an elastic sheet that can be extended over at least a portion of the periodontal defect and affixed to gingival tissue by a suture. In this embodiment, the sheet comprises a hole to receive the tooth and the sheet is pulled over the periodontal defect.

FIG. 2 is a schematic side view of another embodiment of the device that shields all or a portion of the periodontal defect from material that slows healing of the periodontal defect. The device comprises an elastic sheet having an adhesive that can be glued to at least a portion of the tooth on one side and then the other side can be extended over all or at least a portion of the periodontal defect and affixed to gingival tissue.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding the numerical ranges and parameters set forth herein, the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

Reference will now be made in detail to certain embodiments of the invention, examples of which are illustrated in the accompanying drawings. While the invention will be described in conjunction with the illustrated embodiments, it will be understood that they are not intended to limit the invention to those embodiments. On the contrary, the invention is intended to cover all alternatives, modifications, and equivalents that may be included within the invention as defined by the appended claims.

The headings below are not meant to limit the disclosure in any way; embodiments under any one heading may be used in conjunction with embodiments under any other heading.

### DEFINITIONS

It is noted that, as used in this specification and the appended claims, the singular forms “a,” “an,” and “the,” include plural referents unless expressly and unequivocally limited to one referent. Thus, for example, reference to “a barrier” includes one, two, three or more barriers.

The term “practitioner” or “user” means a person who is using the methods and/or devices of the current disclosure on the patient. This term includes, without limitation, doctors (e.g., surgeons, interventional specialists, physicians), nurses, nurse practitioners, other medical personnel, clinicians, dentists, veterinarians, or scientists.

The term “mammal” refers to organisms from the taxonomy class “mammalian,” including but not limited to humans, other primates such as chimpanzees, apes, orangutans and monkeys, rats, mice, cats, dogs, pigs, cows, horses, etc. In various embodiments, the mammal is a human patient.

“Periodontal disease” includes any condition that affects the gums and other structures supporting the teeth. The most common form of periodontal disease is caused by bacterial infections. These bacteria grow in a sticky film called dental plaque that sticks on the tooth surfaces next to the gums. The bacteria can cause inflammation, spread and destroy the gums and the supporting bone around the teeth. The mildest form of periodontal disease is gingivitis, which affects only the gums. More severe periodontal disease damages the other supporting structures including the periodontal ligament and/or bone structure of the tooth or alveolar bone, referred to herein as “periodontal defect.”

The term “therapeutic agent” may be used interchangeably herein with the terms “drug,” “therapeutically effective amount,” and “active pharmaceutical ingredient” or “API.” It will be understood that unless otherwise specified a “therapeutic agent” formulation may include more than one therapeutic agent, wherein exemplary combinations of therapeutic agents include a combination of two or more drugs. The therapeutic agent provides a concentration gradient of the therapeutic agent for delivery to the site. The therapeutic agent can also be bone material (e.g., bone, demineralized bone, surface demineralized bone, bone morphogenic protein, bone substitute material, etc.)

A “therapeutically effective amount” or “effective amount” is such that when administered, the drug results in alteration of the biological activity, such as, for example, inhibition of inflammation, reduction or alleviation of periodontal disease, etc.

The term “biodegradable” includes that all or parts of the material will degrade over time by the action of enzymes, by hydrolytic action and/or by other similar mechanisms in the oral cavity. In various embodiments, “biodegradable” includes that the material can break down or degrade within the oral cavity to non-toxic components after or while a therapeutic agent has been or is being released. By “bioerodible” it is meant that the material or portion thereof will erode or degrade over time due, at least in part, to contact with substances found in the surrounding tissue, fluids or by cellular action. By “bioresorbable” it is meant that the material or portion thereof will be broken down and resorbed within the human body, for example, by a cell or tissue. “Biocompatible” means that the material will not cause substantial tissue irritation or necrosis at the target tissue site.

“Treating” or “treatment” of a disease or condition refers to executing a protocol that may include administering one or more devices and/or drugs to a patient (human, normal or otherwise or other mammal), in an effort to alleviate signs or symptoms of the disease or condition. Alleviation can occur prior to signs or symptoms of the disease or condition appearing, as well as after their appearance. Thus, treating or treatment includes preventing or prevention of disease or undesirable condition (e.g., preventing the disease from occurring in a patient, who may be predisposed to the disease but has not yet been diagnosed as having it). In addition, treating or treatment does not require complete alleviation of signs or symptoms, does not require a cure, and specifically includes protocols that have only a marginal effect on the patient. Treatment can include inhibiting the disease, e.g., arresting its development; or relieving the disease, e.g., causing regression of the disease. For example, treatment can include reducing acute or chronic inflammation; alleviating pain and mitigating and inducing re-growth of new periodontal ligament, bone and other tissues; as an adjunct in orthognathic surgery; any elective cosmetic surgical or repair procedure or so forth.

### Periodontal Devices

Devices and methods are provided that protect the periodontal defect from saliva, other liquids, food, bacteria and/or other material that slows healing of the periodontal defect. In some embodiments, the devices and methods provided reduce the number of surgical procedures required to cut into gingival tissue that has healed from prior surgeries.

In some embodiments, the devices and methods allow guided tissue regeneration where the cementum, alveolar bone and periodontal ligament producing cells have the ability to become established on the tooth root surface by isolating the periodontal defect from unwanted saliva, other liquids, food, bacteria and/or other material that slows healing of the periodontal defect. The devices and methods provided allow proper healing of the periodontal defect and, in some embodiments, gingival tissue can be attached to it.

In some embodiments, the device utilizes a thin polymer barrier placed around the circumference of the affected tooth and this thin polymer barrier can be glued or sutured in place to form a water-tight seal. The gum tissue is then sutured as tightly as possible over the top of this polymer barrier. Without such a barrier, fluids easily access the bone defect attempting to repair itself and interfere with the healing process. With this barrier, there is no direct path for unwanted fluids to enter the defect allowing the healing process to occur. This barrier can be made of the dental biomaterials or implantable polymers. In some embodiments, the barrier can come in a circular sheet form with a hole in the center to place over the tooth, stretching the flexible polymer down to the appropriate level where a standard temporary dental glue has been previously applied. The polymer sheet can be cut to fit between unaffected teeth if necessary.

Once the defect has repaired itself, the sutures can be removed and the flexible sheet easily removed and temporary glue can be removed without re-cutting the gum tissue. In some embodiments, the device can be used in combination with growth factors placed within the bone defect.

In some embodiments, there is a device for treating a periodontal defect adjacent to a tooth, the device comprising a barrier configured to reduce an amount of material from entering into the periodontal defect, the barrier having a first region configured to retain a portion of the barrier against at least a portion of the tooth and a second region configured to extend over at least a portion of the periodontal defect adjacent to the tooth so as to reduce the amount of material from entering into the periodontal defect.

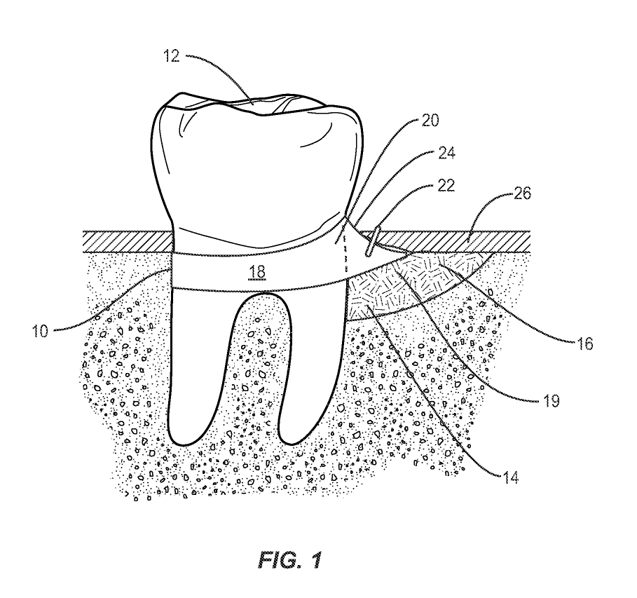

Referring to FIG. 1, it is a schematic front view of an embodiment of the device that shields all or a portion of the periodontal defect from material that slows healing of the periodontal defect. The device comprises a barrier 18, shown as an elastic sheet that is configured to reduce an amount of material from entering into the periodontal defect, the barrier has a first region 10 configured to retain a portion of the barrier against at least a portion of the tooth. The tooth or teeth that the first region of the barrier contacts can be healthy where there is no periodontal disease surrounding it (shown next to 10) or the tooth or teeth can be unhealthy where there is periodontal disease surrounding it shown as 19. The first region 10 and the second region 24 of the barrier are configured to extend over at least a portion of the periodontal defect 19 adjacent to the tooth 12 so as to reduce the amount of material from entering into the periodontal defect.

In some embodiments, the barrier is a circumference that is smaller, the same size, or just larger than the circumference of the tooth and it can be stretched around the circumference of the tooth. The barrier may have a cut out or hole above 20 to allow the barrier to be slid over the tooth 12. In some embodiments, the hole can be in the center of the barrier. In some embodiments, the barrier can be pierceable by pressure that allows the tooth to pass through it. In some embodiments, the barrier can be a sheet, film or band. The barrier, in some embodiments, may have a crease or marking so as to identify the second region 24 and indicate to the practitioner that the second region can be sutured to the gum 26 above the distal end 16 of the periodontal defect. The barrier can be extended in a longitudinal axis above and parallel to the gum. The second region 24 can be a tail configured to be attached to the gum (e.g., by suture or an adhesive disposed on its bottom surface). The second region 24 can be monolithic with the entire barrier. In this way, the barrier prevents saliva, other liquids, food, bacteria and/or other material that slows healing of the periodontal defect.

The barrier 18 at its second region 24 can have an attachment member 22 (shown as a suture) configured to allow the second region to be attached to the gum 22 to provide a water-tight seal. In some embodiments, the second region of the barrier is configured to support the gum. The periodontal defect can be packed with a therapeutic agent 14 (e.g., bone morphogenic protein) that allows bone growth to aid healing. The practitioner fastens the barrier 18 by slipping it over the tooth 12 and then extending the second region 24 of the barrier over the periodontal defect 19 and attaching it to the gum 26 using attachment member 22. The second portion 24 of the barrier 18 may contain one or more channels, grooves, slits, loops, hooks, and/or barbs that can be larger than #000000, #00, #0, #1, #2, #3, #4, #5, or #6, range so that the suture can pass through the surface of the barrier. In some embodiments, there are no one or more channels, grooves, slits, loops, hooks, and/or barbs on or in the barrier. The barrier can be pierceable by a needle or other sharp instrument so as to allow suturing. In alternate embodiments, the second region, first region, or all or a portion thereof can contain adhesive on its tissue contacting side so as to allow placement of the barrier on the gum, and or tooth.

It will be understood by those of ordinary skill in the art that although the attachment member is shown as a suture, other attachment means can be used, such as for example, a yarn, thread, line, wire, adhesive, or the like. In some embodiments, the attachment member comprises a loop, hook, barb, suture, band, staple, adhesive material or a combination thereof that is configured to be affixed to gingival tissue. In some embodiments, the attachment member comprises a suture configured to be removably affixed to gingival tissue.

Unlike prior art devices, the present device is a novel way of treating periodontal defects by placing the device next to the tooth.

The barrier 18 can be an elastic sheet, film, tape, or other elongated structure that can be flat and/or smooth. The barrier can have its surface area maximized for optimum soft tissue holding. In some embodiments, the barrier can have protrusions projecting from its tissue contacting surface (bottom surface), and/or its top surface that can prevent microbial growth.

In some embodiments, the barrier can be from about 0.1 mm, 0.25 mm, 0.5 mm, 1.0 mm, 2 mm, 5 mm, 10 mm, 15 mm, to about 20 mm thick. In some embodiments, the barrier can be from about 1 mm to about 2 mm, or from about 3 mm to about 10 mm in length. The barrier is configured for isolating the tooth root surface from gingival epithelium and gingival connective tissues during healing. This type of isolation enhances migration of alveolar bone cells, bone cementum cells, and periodontal ligament cells for proper healing of the periodontal defect.

The barrier is comprises flexible material. In some embodiments, the barrier may comprise polyurethane, polyurea, polyether(amide), PEBA, thermoplastic elastomeric olefin, copolyester, and styrenic thermoplastic elastomer, polypropylene, nylon, rubber, plastic, collagen, poly (alpha-hydroxy acids), poly (lactide-co-glycolide) (PLGA), polylactide (PLA), polyglycolide (PG), polyethylene glycol (PEG) conjugates of poly (alpha-hydroxy acids), poly(orthoester)s (POE), polyaspirins, polyphosphagenes, collagen, starch, pre-gelatinized starch, hyaluronic acid, chitosans, gelatin, alginates, albumin, fibrin, vitamin E analogs, such as alpha tocopheryl acetate, d-alpha tocopheryl succinate, D,L-lactide, or L-lactide, -caprolactone, dextrans, vinylpyrrolidone, polyvinyl alcohol (PVA), PVA-g-PLGA, PEGT-PBT copolymer (polyactive), PEO-PPO-PAA copolymers, PLGA-PEO-PLGA, PEG-PLG, PLA-PLGA, poloxamer 407, PEG-PLGA-PEG triblock copolymers, SAIB (sucrose acetate isobutyrate) or combinations thereof. The barrier can be the same or different colors or can be transparent or combinations thereof.

In some embodiments, the barrier can have a modulus of elasticity in the range of about 1×10² to about 6×10⁵ dyn/cm², or 2×10⁴ to about 5×10⁵ dyn/cm², or 5×10⁴ to about 5×10⁵ dyn/cm². In some embodiments, the tissue contacting surface of the barrier can have an adhesive disposed on a portion or all of the tissue contacting surface of the barrier. In some embodiments, the barrier can have a therapeutic agent disposed on its tissue contacting surface or a lubricant can be disposed thereon so as to ease of placement over the tooth. In some embodiments, the barrier has a adhesive on its tissue contacting surface (bottom surface) and an anti-adhesive agent disposed on its top surface to prevent cells from sticking to its top surface.

When the attachment member comprises a suture, it may be resorbable or permanent in nature depending upon the type of material from which it is made. As used herein, “suture” refers to any flexible structure that can be stretched between two points and includes, without limitation, traditional suture material, single or multiple stranded threads, or a mesh structure. Sutures may be made from silk, nylon, linen, cotton, chromic gut, plain gut, cat gut, vicryl, polyglactin, polyester, polypropylene, stainless steel, synthetic polymers having glycolic acid ester linkages subject to hydrolytic degradation to non-toxic tissue compatible absorbable components, including polyglycolic acid. The sutures may be monofilamentary or braided, absorbable or non-absorbable. The suture may be of any length. In various embodiments, the suture is long enough to be fastened around the gum.

In some embodiments, the suture may be a preformed loop or string extending from the barrier. The suture may be of any thickness provided it can be attached to or pass through the gum tissue. In some embodiments, the suture may be thick to provide a maximized surface area for optimum soft tissue holding. In some embodiments, the diameter of the suture is about 0.25 mm to about 1 mm to hold the soft tissue. In some embodiments, the barrier and/or suture may contain a therapeutic agent disposed within or on it.

A variety of bioabsorbable polymers can be used to make the suture. Examples of suitable biocompatible, bioabsorbable polymers include aliphatic polyesters, poly(amino acids), copoly(ether-esters), polyalkylenes oxalates, polyamides, tyrosine derived polycarbonates, poly(iminocarbonates), polyorthoesters, polyoxaesters, polyamidoesters, polyoxaesters containing amine groups, poly(anhydrides), polyphosphazenes, biomolecules (i.e., biopolymers such as collagen, elastin, bioabsorbable starches, etc.) or blends thereof. Polyesters include, but are not limited to, homopolymers and copolymers of lactide (which includes lactic acid, D-, L- and meso lactide), glycolide (including glycolic acid), caprolactone, p-dioxanone (1,4-dioxan-2-one), trimethylene carbonate (1,3-dioxan-2-one), alkyl derivatives of trimethylene carbonate, delta-valerolactone, beta-butyrolactone, gamma-butyrolactone, epsilon-decalactone, hydroxybutyrate, hydroxyvalerate, 1,4-dioxepan-2-one (including its dimer 1,5,8,12-tetraoxacyclotetradecane-7,14-dione), 1,5-dioxepan-2-one, 6,6-dimethyl-1,4-dioxan-2-one 2,5-diketomorpholine, pivalolactone, alpha-diethylpropiolactone, ethylene carbonate, ethylene oxalate, 3-methyl-1,4-dioxane-2,5-dione, 3,3-diethyl-1,4-dioxan-2,5-dione, 6,8-dioxabicycloctane-7-one or polymer blends thereof.

In some embodiments, the suture and/or barrier can comprise shape memory polymers including various polyethers, polyacrylates, polyamides, polysiloxanes, polyurethanes, polyether amides, polyurethane/ureas, polyether esters, or urethane/butadiene copolymers or a combination thereof.

Sutures may be of different sizes depending on the procedure being performed. Sutures can range in size from #000000 (#6-0 or #6/0), #00 (#2-0 or #2/0), #0, #1, #2, #3, #4, #5, #6, with #000000 being the smallest.

In some embodiments, there is a device for treating a periodontal defect adjacent to a tooth, the device comprising a barrier configured to reduce an amount of material from entering into the periodontal defect, the barrier having a first region comprising an interior surface having an adhesive disposed on a portion of the interior surface to retain a portion of the first region against a surface of the tooth; and a second region configured to extend over at least a portion of the periodontal defect adjacent to the tooth so as to reduce the amount of material from entering into the periodontal defect.

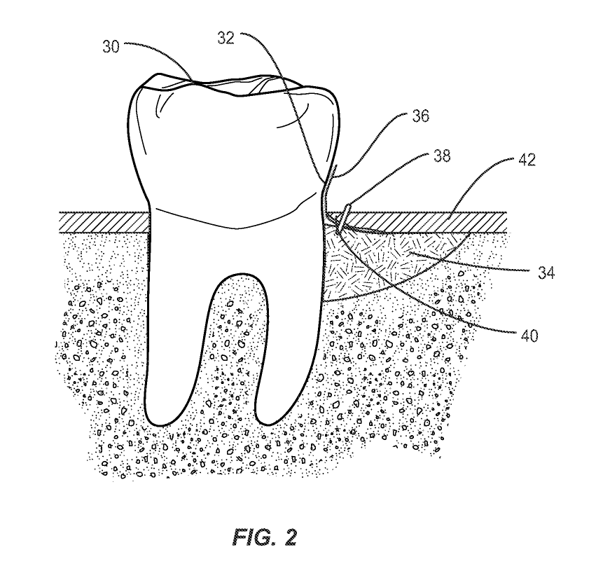

FIG. 2 is a schematic side view of another embodiment of the device that shields all or a portion of the periodontal defect 34 from material that slows healing of the periodontal defect. The device comprises an elastic barrier shown as a sheet having a first region 36 that has a tissue contacting surface having an adhesive 32 disposed on one of its surfaces that allows the barrier to be glued to the tooth 30 and the second region 40 of the barrier is configured to receive an attachment member (e.g., a suture, staple, adhesive, etc.). The second region 40 of the barrier can extend over all or a portion of the periodontal defect and be attached to the gum 42. In this way, the barrier is stretched over the periodontal defect and then the gum is attached to the barrier. In some embodiments, the barrier can also support the gum tissue as the defect heals. Once the appropriate time is reached for periodontal healing, the barrier is removed from the defect by removing the adhesive with an adhesive remover and then removing the attachment member. The barrier is slid out once the periodontal defect is healed or substantially healed.

Before, the device is attached to the gum tissue, in some embodiments, a therapeutic agent can be added to the periodontal defect. Such therapeutic agent can be bone replacement material (e.g., bone grafts, alveolar bone cells, and/or periodontal ligament tissue, demineralized bone, etc.) placed in the defect to aid in re-growing the slow growing alveolar bone, and/or periodontal ligament. The therapeutic agent can be placed before, during or after the barrier is implanted. When the periodontal defect is successfully repaired the alveolar bone, and/or periodontal ligament will be regenerated.

In the embodiments shown in FIGS. 1 and 2, the barrier is extended above and horizontally over the defect. The barrier functions to isolate and maintain space above the periodontal defect. This space and isolation during the initial healing process will reduce migration of gingival epithelium cells, gingival connective tissue cells, and/or other soft tissue cells and enables the periodontal ligament to become re-established in a proper sequence resulting in a new periodontal attachment. It will also allow cementum cells, periodontal ligament producing cells and alveolar bone cells to migrate in and permit ingrowth of periodontal ligament and alveolar bone to repair the periodontal defect.

It should be understood by one of ordinary skill in the art that the barrier can be one piece. Alternatively, the barrier can be two or more separate pieces that are attached together by any attachment means (e.g. adhesive, snap-fit junction, push fitting, mating pairs, etc.) so that it can be customized to extend over the defect. In some embodiments, the barrier can have telescoping length and/or width to adjust to the size of the defect.

After the periodontal defect has healed, the gingival epithelium cells, and gingival connective tissue or other soft tissue will cover the barrier (e.g., usually in a few weeks or months after the device is placed over the defect). In a subsequent visit, the practitioner in a minimally invasive procedure can simply remove the suture on the tooth and pull the barrier out of the now healed defect and there will be no need for subsequent surgeries that cut into the healed soft tissue to remove the device. Therefore, pain and discomfort to the patient is reduced and there is less need for invasive surgical procedures.

In some embodiments the barrier can be angled in a downward plane to the tooth or gums or an upward plane leading away from the tooth or gums. The increased space and isolation during the initial healing process by the barrier will reduce migration of gingival epithelium cells, gingival connective tissue cells, and/or other soft tissue cells and enables the periodontal ligament to become re-established in a proper sequence resulting in a new periodontal attachment. It will also allow cementum cells, periodontal ligament producing cells and alveolar bone cells to migrate in and permit ingrowth of periodontal ligament and alveolar bone to repair the periodontal defect. It will also prevent or inhibit the bone replacement material (e.g., graft material) from being compressed.

In some embodiments, the barrier comprises a mesh, or web that comprises fibers in either a random, or organized fashion, threads, yarns, nets, knits, weaves, laces, felts of fibers, sheets, bands, membranes, and/or foam, which will allow certain cell ingrowth (e.g., alveolar bone cells, bone cementum cells, cementoblasts, periodontal ligament cells). The barrier will reduce passage of gingival epithelium cells, gingival connective tissue cells, other soft tissue cells, fibroblasts, mast cells, neutrophils, monocytes, lymphocytes, eosinophils, basophils, proteoglycans, and/or inflammatory components that may impair healing of the periodontal defect. In some embodiments, the barrier has a thickness of about 0.1 mm to about 0.5 mm. In some embodiments, the barrier comprises a top surface that is impervious or non-porous to fluids.

In some embodiments, the barrier is non-porous. However, in some embodiments, the barrier can have some porosity so long as the pore sizes are small enough to substantially preclude certain cell passage and ingrowth. Such a barrier may be advantageous for certain applications, for example, where passage of nutrients or gasses across the barrier is important.

In some embodiments, the first region of the barrier comprises an exterior surface impervious to liquid material and the barrier has an interior surface having an adhesive disposed on all or at least a portion of the interior surface that can contact the tooth and/or gums to keep the barrier in position as shown in FIG. 2.

The barrier may be made of non-biodegradable material, such as for example, polyurethane, polyurea, polyether(amide), PEBA, thermoplastic elastomeric olefin, copolyester, and styrenic thermoplastic elastomer, polypropylene, nylon, rubber, steel, aluminum, stainless steel, titanium, metal alloys with high non-ferrous metal content and a low relative proportion of iron, carbon fiber, glass fiber, plastics, ceramics or combinations thereof.

In some embodiments, the barrier may be biodegradable and comprise natural or synthetic polymers. In some embodiments, the barrier comprises poly (alpha-hydroxy acids), poly (lactide-co-glycolide) (PLGA), polylactide (PLA), polyglycolide (PG), polyethylene glycol (PEG) conjugates of poly (alpha-hydroxy acids), poly(orthoester)s (POE), polyaspirins, polyphosphagenes, collagen, starch, pre-gelatinized starch, hyaluronic acid, chitosans, gelatin, alginates, albumin, fibrin, vitamin E analogs, such as alpha tocopheryl acetate, d-alpha tocopheryl succinate, D,L-lactide, or L-lactide, -caprolactone, dextrans, vinylpyrrolidone, polyvinyl alcohol (PVA), PVA-g-PLGA, PEGT-PBT copolymer (polyactive), methacrylates, poly (N-isopropylacrylamide), PEO-PPO-PEO (pluronics), PEO-PPO-PAA copolymers, PLGA-PEO-PLGA, PEG-PLG, PLA-PLGA, poloxamer 407, PEG-PLGA-PEG triblock copolymers, SAIB (sucrose acetate isobutyrate) or combinations thereof. As persons of ordinary skill are aware, mPEG may be used as a plasticizer for PLGA, but other polymers/excipients may be used to achieve the same effect. In some embodiments, the barrier comprises poly(lactide-co-glycolide) (PLGA), polylactide (PLA), polyglycolide (PGA), D-lactide, D,L-lactide, L-lactide, D,L-lactide-ε-caprolactone, D,L-lactide-glycolide-E-caprolactone or a combination thereof.

In some embodiments, there is a method for treating a periodontal defect adjacent to a tooth, the method comprising providing a barrier configured to reduce an amount of material from entering into the periodontal defect, the barrier having a first region configured to retain a portion of the barrier against at least a portion of the tooth and a second region configured to extend over at least a portion of the periodontal defect adjacent to the tooth so as to reduce the amount of material from entering into the periodontal defect; placing the first region of the barrier against the portion of the tooth so as to retain it against the portion of the tooth; and extending the second region of the barrier over at least a portion of the periodontal defect; and attaching the second region of the barrier to gingival tissue adjacent to the periodontal defect so as to reduce the amount of material from entering into the periodontal defect.

In some embodiments, a method is provided for treating a periodontal defect where the method comprises administering bone replacement material into the periodontal defect after separating soft tissue from at least a portion of the tooth located at the periodontal defect.

### Bone Replacement Material

In some embodiments, to enhance bone growth at the periodontal defect, a bone replacement material can be used in the area. Bone replacement materials can include bone particles from fully mineralized bone, and demineralized bone particles and combinations thereof. The bone particles can be autograft, allograft, xenogenic, transgenic bone particles or a combination thereof.

In some embodiments, the bone replacement material includes bone cements. Bone cements are commonly provided in two or more components. The first component is usually a powder and the second component is usually in liquid form. Examples of bone cement materials include those based on acrylate materials, which can react by polymerization to form acrylate polymers.

In some embodiments, the bone cement comprises powder that includes, for example, calcium phosphate based powders and poly-methyl-methacrylate based powders. Any of various osteoconductive powders, such as ceramics, calcium sulfate or calcium phosphate compounds, hydroxyapatite, magnesium and Si based cements, deproteinized bone, corals, and certain polymers, can alternatively or additionally be used in the bone cement.

Typically, bone cement can be formed by mixing a liquid acrylate monomer with a powder such as acrylate polymer using a mixing element, where the mixing can be accomplished by hand or machine. The resulting mixture has a paste or dough-like consistency. Typically, the components of the mixture react, involving polymerization of the acrylate monomer and copolymerization with the acrylate polymer particles. The viscosity of the cement composition increases during the reaction, resulting in a hard cement. The curing reaction of a bone cement material is generally exothermic.

Typically, the bone cement is prepared prior to injection by mixing bone-cement powder (e.g., poly-methyl-methacrylate (PMMA)), a liquid monomer (e.g., methyl-methacrylate monomer (MMA)), an x-ray contrast agent (e.g., barium sulfate), and an activator of the polymerization reaction (e.g., N,N-dimethyl-p-toluidine) to form a fluid mixture. Other additives including but not limited to stabilizers, drugs, fillers, dyes and fibers may also be included in the bone cement. Since the components react upon mixing, immediately leading to the polymerization, the components of bone cement should be kept separate from each other until the user is ready to form the desired bone cement. Once mixed, the user must work very quickly because the bone cement sets and hardens rapidly.

Other examples of bone cement compositions and/or their uses are discussed in US Patent Publication No. 20080109003, U.S. Pat. No. 7,138,442; U.S. Pat. No. 7,160,932; U.S. Pat. No. 7,014,633; U.S. Pat. No. 6,752,863; U.S. Pat. No. 6,020,396; U.S. Pat. No. 5,902,839; U.S. Pat. No. 4,910,259; U.S. Pat. No. 5,276,070; U.S. Pat. No. 5,795,922; U.S. Pat. No. 5,650,108; U.S. Pat. No. 6,984,063; U.S. Pat. No. 4,588,583; U.S. Pat. No. 4,902,728; U.S. Pat. No. 5,797,873; U.S. Pat. No. 6,160,033; and EP 0 701 824, the entire disclosures of which are herein incorporated by reference.

In some embodiments, other additives can be mixed with the bone replacement material and this includes bioactive substances. Thus, one or more bioactive substances can be combined with the bone replacement by soaking or immersing the bone replacement in a solution or dispersion of the desired bioactive substance(s). Bioactive substances include physiologically or pharmacologically active substances that act locally or systemically in the host. In certain applications, the bone cement can be used as a time-release drug delivery device for drugs or other bioactive substances that are to be delivered to the surgical site.

Bioactive substances which can be readily combined with the bone replacement material, e.g., collagen, insoluble collagen derivatives, etc., and soluble solids and/or liquids dissolved therein; antiviricides, particularly those effective against HIV and hepatitis; antimicrobials and/or antibiotics such as erythromycin, bacitracin, neomycin, penicillin, polymycin B, tetracyclines, biomycin, chloromycetin, and streptomycins, cefazolin, ampicillin, azactam, tobramycin, clindamycin or gentamicin, etc.; biocidal/biostatic sugars such as dextran, glucose, etc.; amino acids; peptides; vitamins; inorganic elements; co-factors for protein synthesis; hormones; endocrine tissue or tissue fragments; synthesizers; enzymes such as collagenase, peptidases, oxidases, etc.; polymer cell scaffolds with parenchymal cells; angiogenic agents or polymeric carriers containing such agents; collagen lattices; antigenic agents; cytoskeletal agents; cartilage fragments; living cells such as chondrocytes, bone marrow cells, mesenchymal stem cells, natural extracts, genetically engineered living cells or otherwise modified living cells; DNA delivered by plasmid or viral vectors; tissue transplants; demineralized bone powder; autogenous tissues such as blood, serum, soft tissue, bone marrow, etc.; bioadhesives, bone morphogenic proteins (BMPs); osteoinductive factor; fibronectin (FN), osteonectin (ON); endothelial cell growth factor (ECGF); cementum attachment extracts (CAE); ketanserin; human growth hormone (HGH); animal growth hormones; epidermal growth factor (EGF); interleukin-1 (IL-1); human alpha thrombin; transforming growth factor (TGF-beta); insulin-like growth factor (IGF-1); platelet derived growth factors (PDGF); fibroblast growth factors (FGF, bFGF, etc.); periodontal ligament chemotactic factor (PDLGF); somatotropin; bone digestors; antitumor agents; immuno-suppressants; permeation enhancers, e.g., fatty acid esters such as laureate, myristate and stearate monoesters of polyethylene glycol, enamine derivatives, alpha-keto aldehydes, etc.; or nucleic acids. When employed, the total amount of bioactive substance can represent from about 0.1 to about 60 weight percent of the bone replacement material.

In some embodiments, the bioactive agent is mixed before, with, or after the bone replacement material is added to the periodontal defect. In some embodiments, the bioactive agent comprises the family of proteins known as the transforming growth factor-beta (TGFβ) superfamily of proteins, which includes the activins, inhibins, or bone morphogenetic proteins (BMPs). In some embodiments, the active agent includes at least one protein from the subclass of proteins known generally as BMPs. BMPs have been shown to possess a wide range of growth and differentiation activities, including induction of the growth and differentiation of bone, connective, kidney, heart, and neuronal tissues. See, for example, descriptions of BMPs in the following publications: BMP-2, BMP-3, BMP-4, BMP-5, BMP-6, and BMP-7 (disclosed, for example, in U.S. Pat. No. 5,013,649 (BMP-2 and BMP-4); U.S. Pat. No. 5,116,738 (BMP-3); U.S. Pat. No. 5,106,748 (BMP-5); U.S. Pat. No. 5,187,076 (BMP-6); and U.S. Pat. No. 5,141,905 (BMP-7)); BMP-8 (disclosed in PCT WO 91/18098); BMP-9 (disclosed in PCT WO 93/00432); BMP-10 (disclosed in PCT WO 94/26893); BMP-11 (disclosed in PCT WO 94/26892); BMP-12 or BMP-13 (disclosed in PCTWO 95/16035); BMP-15 (disclosed in U.S. Pat. No. 5,635,372); BMP-16 (disclosed in U.S. Pat. No. 6,331,612); MP52/GDF-5 (disclosed in PCT WO 93/16099); or BMP-17 or BMP-18 (disclosed in U.S. Pat. No. 6,027,917). The entire disclosure of these references is herein incorporated by reference. Other TGF-proteins that may be useful as the active agent of the bone cement paste include Vgr-2 and any of the growth and differentiation factors (GDFs), such as, for example, GDF-5.

A subset of BMPs that may be used in certain embodiments includes BMP-2, BMP-4, BMP-5, BMP-6, BMP-7, BMP-8, BMP-9, BMP-10, BMP-11, BMP-12 or BMP-13. In some embodiments, the composition contains two or more active agents (e.g., BMP-2 and BMP-4). Other BMPs and TGF-proteins may also be used.

The active agent may be recombinantly produced, or purified from another source. The active agent, if a TGFβ protein such as a BMP, or other dimeric protein, may be homodimeric, or may be heterodimeric with other BMPs (e.g., a heterodimer composed of one monomer each of BMP-2 and BMP-6) or with other members of the TGF-β superfamily, such as activins, inhibins and TGF-β (e.g., a heterodimer composed of one monomer each of a BMP and a related member of the TGF-β superfamily). Examples of such heterodimeric proteins are described, for example in published PCT Patent Application WO 93/09229.

In some embodiments, the amount of growth factor, (e.g., bone morphogenic protein) may be sufficient to cause bone growth. In some embodiments, the growth factor is rhBMP-2 and is contained in the bone replacement material in an amount of from 1 to 2 mg per cubic centimeter of the bone replacement material. In some embodiments, the amount of rhBMP-2 morphogenic protein is from 2.0 to 2.5 mg per cubic centimeter (cc) of the bone replacement material.

In some embodiments, the growth factor is supplied in a liquid carrier (e.g., an aqueous buffered solution). Exemplary aqueous buffered solutions include, but are not limited to, TE, HEPES (2-[4-(2-hydroxyethyl)-1-piperazinyl]ethanesulfonic acid), MES (2-morpholinoethanesulfonic acid), sodium acetate buffer, sodium citrate buffer, sodium phosphate buffer, a Tris buffer (e.g., Tris-HCL), phosphate buffered saline (PBS), sodium phosphate, potassium phosphate, sodium chloride, potassium chloride, glycerol, calcium chloride or a combination thereof. In various embodiments, the buffer concentration can be from about 1 mM to 100 mM. In some embodiments, the BMP-2 is provided in a vehicle (including a buffer) containing sucrose, glycine, L-glutamic acid, sodium chloride, and/or polysorbate 80.

The bone replacement material may be mixed with additional therapeutic agents. Exemplary therapeutic agents include but are not limited to IL-1 inhibitors, such Kineret® (anakinra), which is a recombinant, non-glycosylated form of the human interleukin-1 receptor antagonist (IL-1Ra), or AMG 108, which is a monoclonal antibody that blocks the action of IL-1. Therapeutic agents also include excitatory amino acids such as glutamate and aspartate, antagonists or inhibitors of glutamate binding to NMDA receptors, AMPA receptors, and/or kainate receptors. Interleukin-1 receptor antagonists, thalidomide (a TNF-α release inhibitor), thalidomide analogues (which reduce TNF-α production by macrophages), quinapril (an inhibitor of angiotensin II, which upregulates TNF-α), interferons such as IL-11 (which modulate TNF-α receptor expression), and aurin-tricarboxylic acid (which inhibits TNF-α), may also be useful as therapeutic agents for reducing inflammation. It is further contemplated that where desirable a pegylated form of the above may be used. Examples of still other therapeutic agents include NF kappa B inhibitors such as antioxidants, such as dithiocarbamate, and other compounds, such as, for example, sulfasalazine.

Examples of therapeutic agents suitable for use also include, but are not limited to, an anti-inflammatory agent, or analgesic agent. Anti-inflammatory agents include, but are not limited to, apazone, celecoxib, diclofenac, diflunisal, enolic acids (piroxicam, meloxicam), etodolac, fenamates (mefenamic acid, meclofenamic acid), gold, ibuprofen, indomethacin, ketoprofen, ketorolac, nabumetone, naproxen, nimesulide, salicylates, sulfasalazine [2-hydroxy-5-[-4-[C2-pyridinylamino)sulfonyl]azo]benzoic acid, sulindac, tepoxalin, and tolmetin; as well as antioxidants, such as dithiocarbamate, steroids, such as cortisol, cortisone, hydrocortisone, fludrocortisone, prednisone, prednisolone, methylprednisolone, triamcinolone, betamethasone, dexamethasone, beclomethasone, fluticasone or a combination thereof.

Suitable analgesic agents include, but are not limited to, acetaminophen, bupivicaine, fluocinolone, lidocaine, opioid analgesics such as buprenorphine, butorphanol, dextromoramide, dezocine, dextropropoxyphene, diamorphine, fentanyl, alfentanil, sufentanil, hydrocodone, hydromorphone, ketobemidone, levomethadyl, mepiridine, methadone, morphine, nalbuphine, opium, oxycodone, papavereturn, pentazocine, pethidine, phenoperidine, piritramide, dextropropoxyphene, remifentanil, tilidine, tramadol, codeine, dihydrocodeine, meptazinol, dezocine, eptazocine, flupirtine, amitriptyline, carbamazepine, gabapentin, pregabalin, or a combination thereof.

In some embodiments, a statin may be used. Statins include, but is not limited to, atorvastatin, simvastatin, pravastatin, cerivastatin, mevastatin (see U.S. Pat. No. 3,883,140, the entire disclosure is herein incorporated by reference), velostatin (also called synvinolin; see U.S. Pat. Nos. 4,448,784 and 4,450,171 these entire disclosures are herein incorporated by reference), fluvastatin, lovastatin, rosuvastatin and fluindostatin (Sandoz XU-62-320), dalvastain (EP Appln. Publn. No. 738510 A2, the entire disclosure is herein incorporated by reference), eptastatin, pitavastatin, or pharmaceutically acceptable salts thereof or a combination thereof. In various embodiments, the statin may comprise mixtures of (+) R and (−)-S enantiomers of the statin. In various embodiments, the statin may comprise a 1:1 racemic mixture of the statin.

In some embodiments, the bone replacement material can comprise antimicrobial agents. Antimicrobial agents to treat infection include by way of example and not limitation, antiseptic agents, antibacterial agents; quinolones and in particular fluoroquinolones (e.g., norfloxacin, ciprofloxacin, lomefloxacin, ofloxacin, etc.), aminoglycosides (e.g., gentamicin, tobramycin, etc.), glycopeptides (e.g., vancomycin, etc.), lincosamides (e.g., clindamycin), cephalosporins (e.g., first, second, third generation) and related beta-lactams, macrolides (e.g., azithromycin, erythromycin, etc.), nitroimidazoles (e.g., metronidazole), penicillins, polymyxins, tetracyclines, or combinations thereof.

Some exemplary antimicrobial agents include, by way of illustration and not limitation, acedapsone; acetosulfone sodium; alamecin; alexidine; amdinocillin; amdinocillin pivoxil; amicycline; amifloxacin; amifloxacin mesylate; amikacin; amikacin sulfate; aminosalicylic acid; aminosalicylate sodium; amoxicillin; amphomycin; ampicillin; ampicillin sodium; apalcillin sodium; apramycin; aspartocin; astromicin sulfate; avilamycin; avoparcin; azithromycin; azlocillin; azlocillin sodium; bacampicillin hydrochloride; bacitracin; bacitracin methylene disalicylate; bacitracin zinc; bambermycins; benzoylpas calcium; berythromycin; betamicin sulfate; biapenem; biniramycin; biphenamine hydrochloride; bispyrithione magsulfex; butikacin; butirosin sulfate; capreomycin sulfate; carbadox; carbenicillin disodium; carbenicillin indanyl sodium; carbenicillin phenyl sodium; carbenicillin potassium; carumonam sodium; cefaclor; cefadroxil; cefamandole; cefamandole nafate; cefamandole sodium; cefaparole; cefatrizine; cefazaflur sodium; cefazolin; cefazolin sodium; cefbuperazone; cefdinir; cefepime; cefepime hydrochloride; cefetecol; cefixime; cefinenoxime hydrochloride; cefinetazole; cefinetazole sodium; cefonicid monosodium; cefonicid sodium; cefoperazone sodium; ceforanide; cefotaxime sodium; cefotetan; cefotetan disodium; cefotiam hydrochloride; cefoxitin; cefoxitin sodium; cefpimizole; cefpimizole sodium; cefpiramide; cefpiramide sodium; cefpirome sulfate; cefpodoxime proxetil; cefprozil; cefroxadine; cefsulodin sodium; ceftazidime; ceftibuten; ceftizoxime sodium; ceftriaxone sodium; cefuroxime; cefuroxime axetil; cefuroxime pivoxetil; cefuroxime sodium; cephacetrile sodium; cephalexin; cephalexin hydrochloride; cephaloglycin; cephaloridine; cephalothin sodium; cephapirin sodium; cephradine; cetocycline hydrochloride; cetophenicol; chloramphenicol; chloramphenicol palmitate; chloramphenicol pantothenate complex; chloramphenicol sodium succinate; chlorhexidine phosphanilate; chloroxylenol; chlortetracycline bisulfate; chlortetracycline hydrochloride; cinoxacin; ciprofloxacin; ciprofloxacin hydrochloride; cirolemycin; clarithromycin; clinafloxacin hydrochloride; clindamycin; clindamycin hydrochloride; clindamycin palmitate hydrochloride; clindamycin phosphate; clofazimine; cloxacillin benzathine; cloxacillin sodium; chlorhexidine, cloxyquin; colistimethate sodium; colistin sulfate; coumermycin; coumermycin sodium; cyclacillin; cycloserine; dalfopristin; dapsone; daptomycin; demeclocycline; demeclocycline hydrochloride; demecycline; denofungin; diaveridine; dicloxacillin; dicloxacillin sodium; dihydrostreptomycin sulfate; dipyrithione; dirithromycin; doxycycline; doxycycline calcium; doxycycline fosfatex; doxycycline hyclate; droxacin sodium; enoxacin; epicillin; epitetracycline hydrochloride; erythromycin; erythromycin acistrate; erythromycin estolate; erythromycin ethylsuccinate; erythromycin gluceptate; erythromycin lactobionate; erythromycin propionate; erythromycin stearate; ethambutol hydrochloride; ethionamide; fleroxacin; floxacillin; fludalanine; flumequine; fosfomycin; fosfomycin tromethamine; fumoxicillin; furazolium chloride; furazolium tartrate; fusidate sodium; fusidic acid; ganciclovir and ganciclovir sodium; gentamicin sulfate; gloximonam; gramicidin; haloprogin; hetacillin; hetacillin potassium; hexedine; ibafloxacin; imipenem; isoconazole; isepamicin; isoniazid; josamycin; kanamycin sulfate; kitasamycin; levofuraltadone; levopropylcillin potassium; lexithromycin; lincomycin; lincomycin hydrochloride; lomefloxacin; lomefloxacin hydrochloride; lomefloxacin mesylate; loracarbef; mafenide; meclocycline; meclocycline sulfosalicylate; megalomicin potassium phosphate; mequidox; meropenem; methacycline; methacycline hydrochloride; methenamine; methenamine hippurate; methenamine mandelate; methicillin sodium; metioprim; metronidazole hydrochloride; metronidazole phosphate; mezlocillin; mezlocillin sodium; minocycline; minocycline hydrochloride; mirincamycin hydrochloride; monensin; monensin sodiumr; nafcillin sodium; nalidixate sodium; nalidixic acid; natainycin; nebramycin; neomycin palmitate; neomycin sulfate; neomycin undecylenate; netilmicin sulfate; neutramycin; nifuiradene; nifuraldezone; nifuratel; nifuratrone; nifurdazil; nifurimide; nifiupirinol; nifurquinazol; nifurthiazole; nitrocycline; nitrofurantoin; nitromide; norfloxacin; novobiocin sodium; ofloxacin; onnetoprim; oxacillin and oxacillin sodium; oximonam; oximonam sodium; oxolinic acid; oxytetracycline; oxytetracycline calcium; oxytetracycline hydrochloride; paldimycin; parachlorophenol; paulomycin; pefloxacin; pefloxacin mesylate; penamecillin; penicillins such as penicillin g benzathine, penicillin g potassium, penicillin g procaine, penicillin g sodium, penicillin v, penicillin v benzathine, penicillin v hydrabamine, and penicillin v potassium; pentizidone sodium; phenyl aminosalicylate; piperacillin sodium; pirbenicillin sodium; piridicillin sodium; pirlimycin hydrochloride; pivampicillin hydrochloride; pivampicillin pamoate; pivampicillin probenate; polymyxin b sulfate; porfiromycin; propikacin; pyrazinamide; pyrithione zinc; quindecamine acetate; quinupristin; racephenicol; ramoplanin; ranimycin; relomycin; repromicin; rifabutin; rifametane; rifamexil; rifamide; rifampin; rifapentine; rifaximin; rolitetracycline; rolitetracycline nitrate; rosaramicin; rosaramicin butyrate; rosaramicin propionate; rosaramicin sodium phosphate; rosaramicin stearate; rosoxacin; roxarsone; roxithromycin; sancycline; sanfetrinem sodium; sarmoxicillin; sarpicillin; scopafungin; sisomicin; sisomicin sulfate; sparfloxacin; spectinomycin hydrochloride; spiramycin; stallimycin hydrochloride; steffimyc in; streptomycin sulfate; streptonicozid; sulfabenz; sulfabenzamide; sulfacetamide; sulfacetamide sodium; sulfacytine; sulfadiazine; sulfadiazine sodium; sulfadoxine; sulfalene; sulfamerazine; sulfameter; sulfamethazine; sulfamethizole; sulfamethoxazole; sulfamonomethoxine; sulfamoxole; sulfanilate zinc; sulfanitran; sulfasalazine; sulfasomizole; sulfathiazole; sulfazamet; sulfisoxazole; sulfisoxazole acetyl; sulfisboxazole diolamine; sulfomyxin; sulopenem; sultamricillin; suncillin sodium; talampicillin hydrochloride; teicoplanin; temafloxacin hydrochloride; temocillin; tetracycline; tetracycline hydrochloride; tetracycline phosphate complex; tetroxoprim; thiamphenicol; thiphencillin potassium; ticarcillin cresyl sodium; ticarcillin disodium; ticarcillin monosodium; ticlatone; tiodonium chloride; tobramycin; tobramycin sulfate; tosufloxacin; trimethoprim; trimethoprim sulfate; trisulfapyrimidines; troleandomycin; trospectomycin sulfate; tyrothricin; vancomycin; vancomycin hydrochloride; virginiamycin; zorbamycin; or combinations thereof.

One method of making the bone replacement material includes adding the powder to the container and adding the liquid and other components to the container and mixing them by hand or machine until the desired consistency of the bone replacement material is reached. Optionally, the mixture can include one or more other optional components such as any of binders, fillers, plasticizers, biostatic/biocidal agents, surface active agents, bioactive substances, or reinforcing components, graft material, cells (e.g., alveolar bone cells, bone cementum cells, cementoblasts, periodontal ligament cells, etc.). A syringe is then filled with the bone replacement material and then delivered to the periodontal defect as discussed above.

### Kits

One or more devices (e.g., barriers, adhesives, needles) may be placed in a kit, which may be sterilizable by radiation in a terminal sterilization step in the final packaging. Terminal sterilization of a product provides greater assurance of sterility than from processes such as an aseptic process, which require individual product components to be sterilized separately and the final package assembled in a sterile environment. In various embodiments, gamma radiation is used in the terminal sterilization step, which involves utilizing ionizing energy from gamma rays that penetrates deeply in the device. Gamma rays are highly effective in killing microorganisms, they leave no residues nor have sufficient energy to impart radioactivity to the device. Gamma rays can be employed when the device is in the package and gamma sterilization does not require high pressures or vacuum conditions, thus, package seals and other components are not stressed. In addition, gamma radiation eliminates the need for permeable packaging materials.

In some embodiments, the device may be packaged in a moisture resistant kit and then terminally sterilized by gamma irradiation. In use the practitioner removes the one or all components from the sterile package for use. In various embodiments, electron beam (e-beam) radiation may be used to sterilize one or more components of the device. E-beam radiation comprises a form of ionizing energy, which is generally characterized by low penetration and high-dose rates. E-beam irradiation is similar to gamma processing in that it alters various chemical and molecular bonds on contact, including the reproductive cells of microorganisms. Beams produced for e-beam sterilization are concentrated, highly-charged streams of electrons generated by the acceleration and conversion of electricity.

Other methods may also be used to sterilize delivery device and/or one or more of its components (e.g., barrier, needles, sutures, etc.), including, but not limited to, gas sterilization, such as, for example, with ethylene oxide or steam sterilization.

In various embodiments, a kit is provided comprising sterile or non-sterile devices (e.g., barrier, needles, sutures, etc.). The kit may include additional parts along with the devices combined together to be used with it (e.g., wipes, syringes, etc.). The kit may include gloves, drapes, wound dressings and other procedural supplies for maintaining sterility of the delivery process, as well as an instruction booklet, DVDs, or CDs, which may include a chart that shows how to use the device.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

1. A device for treating a periodontal defect adjacent to a tooth, the device comprising a barrier comprising a growth factor and configured to reduce an amount of material from entering into the periodontal defect, the barrier being a single elastic piece having a first region configured to retain a portion of the barrier against at least a portion of the tooth and a second region configured to extend over at least a portion of the periodontal defect adjacent to the tooth so as to reduce the amount of material from entering into the periodontal defect, wherein the barrier includes a plurality of projections to prevent microbial growth thereon.

2. A device according to claim 1, wherein (i) the first region of the barrier comprises a hole configured to receive and slide over at least a portion of the tooth to retain at least the first region of the barrier against the portion of the tooth; or (ii) the first region of the barrier comprises a section that upon pressure creates a hole configured to receive and slide over at least a portion of the tooth to retain at least the first region of the barrier against the portion of the tooth.

3. A device according to claim 1, wherein the second region of the barrier is configured to receive an attachment member.

4. A device according to claim 3, wherein the attachment member comprises a loop, hook, barb, suture, band, staple, adhesive material or a combination thereof that is configured to be affixed to gingival tissue.

5. A device according to claim 3, wherein the attachment member comprises a suture configured to be removably affixed to gingival tissue.

6. A device according to claim 1, wherein (i) the first and/or second region of the barrier is impervious to liquid material, or (ii) the second region of the barrier is configured to receive or to be attached to gingival tissue.

7. A device according to claim 1, wherein the first region of the barrier comprises an interior surface having an adhesive disposed on a portion of the interior surface to retain the portion against a surface of the tooth.

8. A device according to claim 2, wherein the first region comprises an exterior surface impervious to liquid material and an interior surface having an adhesive disposed on all or at least a portion of the interior surface.

9. A device according to claim 1, wherein the barrier can be removed without cutting gingival tissue.

10. A device according to claim 4, wherein the barrier can be removed without cutting gingival tissue once a periodontal ligament is regenerated and the gingival tissue comprises gingival epithelium and gingival connective tissue.

11. A device according to claim 1, wherein the barrier comprises a sheet, mesh or web.

12. A device according to claim 1, further comprising bone replacement material disposed between the periodontal defect and the barrier.

13. (canceled)

14. A device for treating a periodontal defect adjacent to a tooth, the device comprising a barrier comprising a growth factor and configured to reduce an amount of material from entering into the periodontal defect, the barrier being a single elastic piece including a plurality of projections to prevent microbial growth thereon and the barrier having a first region comprising (i) a hole configured to receive and slide over at least a portion of one or more teeth to retain at least the first region of the barrier against the portion of the one or more teeth; or (ii) an interior surface having an adhesive disposed on a portion of the interior surface to retain a portion of the first region against a surface of the tooth; and a second region configured to extend over at least a portion of the periodontal defect adjacent to the tooth so as to reduce the amount of material from entering into the periodontal defect.

15. A device according to claim 14, wherein the first region of the barrier is configured to receive an attachment member.

16. A device according to claim 15, wherein the attachment member comprises a loop, hook, barb, suture, staple, or a combination thereof that is configured to contact gingival tissue.

17. A device according to claim 16, wherein the attachment member comprises a suture configured to contact gingival tissue.

18. A method for treating a periodontal defect adjacent to a tooth, the method comprising providing a barrier comprising a growth factor and configured to reduce an amount of material from entering into the periodontal defect, the barrier being a single elastic piece having a first region configured to retain a portion of the barrier against at least a portion of the tooth and a second region configured to extend over at least a portion of the periodontal defect adjacent to the tooth so as to reduce the amount of material from entering into the periodontal defect; placing the first region of the barrier against the portion of the tooth so as to retain it against the portion of the tooth; and extending the second region of the barrier over at least a portion of the periodontal defect; and attaching the second region of the barrier to gingival tissue adjacent to the periodontal defect so as to reduce the amount of material from entering into the periodontal defect; wherein the barrier includes a plurality of projections to prevent microbial growth thereon.

19. A method according to claim 18, wherein placing the first region of the barrier against the portion of the tooth: (i) comprises sliding a hole in the first region of the barrier over at least a portion of the tooth to retain at least the first region of the barrier against the portion of the tooth; or (ii) comprises applying pressure to a section of the first region of the barrier to create a hole in it and subsequently sliding the first region over at least a portion of the tooth to retain at least the first region of the barrier against the portion of the tooth.

20. A method according to claim 18, wherein the first region of the barrier comprises an interior surface having an adhesive disposed on a portion of the interior surface, and the method further comprises applying the adhesive to a surface of the tooth to retain the first region of the barrier against the portion of the tooth.

21. A device according to claim 1, wherein the barrier is configured to be angled in a downward plane toward the tooth or an upward plane leading away from the tooth to promote the regeneration of periodontal ligament in a proper sequence.
